(19) United States
(12) Patent Application Publication
(10) Pub. No.: US 2008/0152552 A1
(43) Pub. Date: Jun. 26, 2008

(54) System and method of recycling spent catalyst in a fluid catalytic cracking unit

(76) Inventors: Brian W. Hedrick, Oregon, IL (US); Gavin P. Towler, Inverness, IL (US)

Correspondence Address: BRINKS HOFER GILSON & LIONE, P.O. BOX 10395, CHICAGO, IL, 60610, US

(21) Appl. No.: 11/643,554

(22) Filed: Dec. 21, 2006

(51) Int. Cl. F27B 15/08

(52) U.S. Cl. 422/145; 208/113

(57) ABSTRACT

Systems and methods of reducing carbon dioxide emissions in a fluid catalytic cracking unit are disclosed. In one example, the method comprises mixing spent catalyst from the reactor and regenerated catalyst from the regenerator to define a catalyst feed. The method further comprises introducing the catalyst feed in the reactor of the unit to react with a reactor feedstock. The catalyst feed has a reactor pass to regenerator pass ratio of between about 5:1 and 15:1 under gasification conditions in the regenerator, thereby reducing carbon dioxide emissions.

### THE NAMES OF THE PARTIES TO A JOINT RESEARCH AGREEMENT

This application is the result of a joint research agreement between UOP, LLC and BP America, Inc.

### BACKGROUND OF THE INVENTION

The present invention relates to systems and methods of recycling spent catalyst in a fluid catalytic cracking unit.

The fluidized catalytic cracking of hydrocarbons is the mainstay process for the production of gasoline and light hydrocarbon products from heavy hydrocarbon charge stocks such as vacuum gas oils or residual feeds. Large hydrocarbon molecules associated with the heavy hydrocarbon feed are cracked to break the large hydrocarbon chains thereby producing lighter hydrocarbons. These lighter hydrocarbons are recovered as product and can be used directly or further processed to raise the octane barrel yield relative to the heavy hydrocarbon feed.

The basic equipment or apparatus for the fluidized catalytic cracking of hydrocarbons has been in existence since the early 1940's. The basic components of the FCC process include a reactor, a regenerator, and a catalyst stripper. The reactor includes a contact zone where the hydrocarbon feed is contacted with a particulate catalyst and a separation zone where product vapors from the cracking reaction are separated from the catalyst. Further product separation takes place in a catalyst stripper that receives catalyst from the separation zone and removes entrained hydrocarbons from the catalyst by counter-current contact with steam or another stripping medium.

The FCC process is carried out by contacting the starting material—generally vacuum gas oil, reduced crude, or another source of relatively high boiling hydrocarbons—with a catalyst made up of a finely divided or particulate solid material. The catalyst is transported like a fluid by passing gas or vapor through it at sufficient velocity to produce a desired regime of fluid transport. Contact of the oil with the fluidized material catalyzes the cracking reaction. The cracking reaction deposits coke on the catalyst. Coke is comprised of hydrogen and carbon and can include other materials in trace quantities such as sulfur and metals that enter the process with the starting material. Coke interferes with the catalytic activity of the catalyst by blocking active sites on the catalyst surface where the cracking reactions take place. Catalyst is traditionally transferred from the stripper to a regenerator for purposes of removing the coke by oxidation with an oxygen-containing gas. An inventory of catalyst having a reduced coke content relative to the catalyst in the stripper, hereinafter referred to as regenerated catalyst, is collected for return to the reaction zone. Oxidizing the coke from the catalyst surface releases a large amount of heat, a portion of which escapes the regenerator with gaseous products of coke oxidation generally referred to as flue gas. The balance of the heat leaves the regenerator with the regenerated catalyst. The fluidized catalyst is continuously circulated from the reaction zone to the regeneration zone and then again to the reaction zone. The fluidized catalyst, as well as providing a catalytic function, acts as a vehicle for the transfer of heat from zone to zone. Catalyst exiting the reaction zone is spoken of as being spent, i.e., partially deactivated by the deposition of coke upon the catalyst. Specific details of the various contact zones, regeneration zones, and stripping zones along with arrangements for conveying the catalyst between the various zones are well known to those skilled in the art.

Refining companies are under increased pressure to reduce CO₂ emissions as a result of carbon tax legislation and other drivers such as a desire to demonstrate long-term sustainability. Roughly 15-25% of refinery CO₂ emissions are cause by the burning of catalyst coke in the FCC regenerator. Thus, there is a need to provide a way to reduce the carbon dioxide emissions of a fluid catalytic cracking unit.

### BRIEF SUMMARY OF THE INVENTION

Embodiments of the present invention generally provide systems and methods of reducing carbon dioxide emissions in fluid catalytic cracking units having a reactor and a regenerator at gasification conditions. The systems and methods of the present invention provide solutions to lessen carbon dioxide emissions of a fluid catalytic cracking unit without excess coke build up, high water vapor concentrations, and multiple regeneration stages.

In one example, the present invention provides a method comprising mixing spent catalyst from the reactor and regenerated catalyst from the regenerator to define a catalyst feed. The method further comprises introducing the catalyst feed in the reactor of the unit to react with a reactor feedstock. The catalyst feed has a reactor pass to regenerator pass ratio of between about 5:1 and 15:1 under gasification conditions in the regenerator.

In another example, the catalyst feed further comprises fresh-makeup catalyst. In this example, the fresh-makeup catalyst is at a predetermined proportional amount relative to the regenerated catalyst. The method further comprises stripping the spent catalyst from the reactor and recovering heat from the spent catalyst to define a rate of recovered heat. Then, the feed gas of the regenerator is heated with the rate of recovered heat from the spent catalyst. This defines a preheated feed gas. The preheated feed gas comprises one of carbon dioxide-oxygen mixture and steam-oxygen mixture. The method further comprises introducing the preheated feed gas in a gasification mode and the spent catalyst in the regenerator to reactivate the spent catalyst.

In yet another example, the present invention provides a system for reducing carbon dioxide emissions in a fluid catalytic cracking system having a regenerator and reactor. The system comprises a spent catalyst recycle conduit in fluid communication with the reactor. The recycle conduit is configured to recycle spent catalyst from the reactor. The system further comprises a mixing chamber in fluid communication with the recycle conduit. The mixing chamber is configured to mix spent catalyst from the reactor and regenerated catalyst from the regenerator to define a catalyst feed. The system further comprises a catalyst feed conduit in fluid communication with the reactor and the mixing chamber. The catalyst feed conduit is configured to introduce the catalyst feed in the reactor of the system. The catalyst feed comprises a reactor pass to regenerator pass ratio of between about 5:1 and 15:1 under gasification conditions in the regenerator.

Further objects, features, and advantages of the present invention will become apparent from consideration of the following description and the appended claims when taken in connection with the accompanying drawings.

### BRIEF DESCRIPTION OF THE DRAWINGS

FIG. 1 is a schematic diagram of a fluid catalytic cracking unit having reduced carbon dioxide emissions in accordance with one embodiment of the present invention;

FIG. 2 is a schematic diagram of a system for reducing carbon dioxide emissions in a FCC unit having a mixing chamber in accordance with one embodiment of the present invention; and

FIG. 3 is a flowchart of a method of recycling spent catalyst in the fluid catalytic cracking unit of FIG. 1.

### DETAILED DESCRIPTION OF THE INVENTION

Embodiments of the present invention generally provide systems and methods of recycling spent catalyst of a fluid catalytic cracking (FCC) unit having a reactor and a regenerator to reduce carbon dioxide emissions in the FCC unit. In one example, this is accomplished by using a mixing chamber to receive recycled spent catalyst from the reactor and reactivated catalyst from the regenerator to define a catalyst feed. Fresh makeup catalyst may also be added. The catalyst feed has a reactor pass to regenerator pass ratio of between about 5:1 and 15:1 under gasification conditions in the regenerator. Thus, less coke is proportionally burned in the regenerator, thereby reducing carbon dioxide emissions.

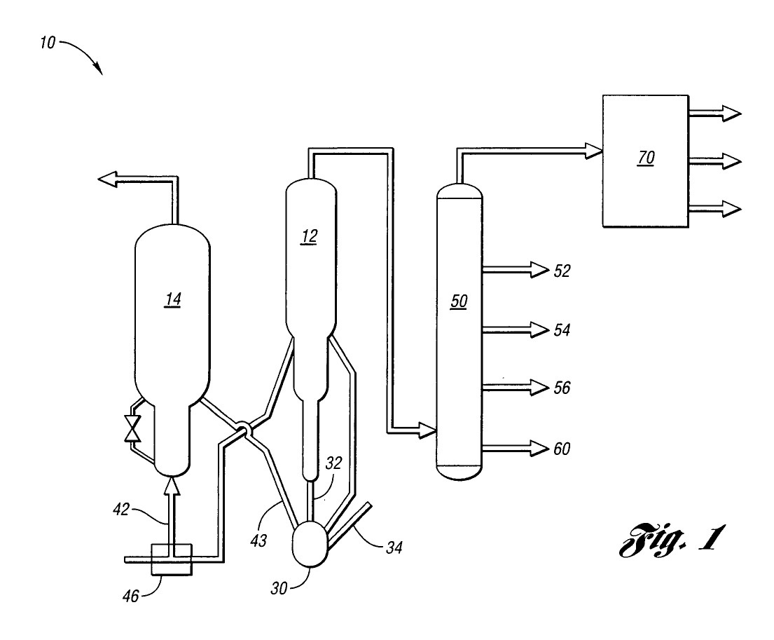

FIG. 1 illustrates a fluid catalytic cracking (FCC) unit 10 having reduced carbon dioxide emissions in accordance with one embodiment of the present invention. As shown, the FCC unit 10 comprises a reactor 12 that is configured to receive a hydrocarbon feedstock and a regenerator 14 in fluid communication with the reactor 12 to receive spent catalyst. The reactor 12 cracks the feedstock therein to an effluent containing hydrocarbons ranging from methane through relatively high boiling point materials along with hydrogen and hydrogen sulfide. During the cracking reaction, a carbonaceous by-product is deposited on the circulating catalyst. This material, termed “coke,” is continuously burned off the spent catalyst in the regenerator 14 as will be mentioned below.

The unit 10 comprises the regenerator 14 for regenerating spent catalyst from the reactor 12. The regenerator 14 is configured to receive a feed gas from an outside source and spent catalyst from the reactor 12. From the reactor 12, the spent catalyst has coke deposited thereon, reducing the activity of the catalyst. The regenerator 14 receives the feed gas to burn the coke off the spent catalyst, thereby producing a flue gas that exits a flue gas line to a flue-gas system. The flue gas may comprise carbon monoxide, hydrogen, carbon dioxide, steam, carbonyl sulfide, and hydrogen sulfide. The regenerator 14 is configured to rejuvenate or reactivate the spent catalyst by the burning the deposited coke off the spent catalyst with the feed gas at predetermined temperatures that is at a relatively high temperature as discussed below.

The regenerator 14 reactivates the catalyst so that, when returned to the reactor 12, the catalyst is in optimum condition to perform its cracking function. The regenerator 14 serves to gasify the coke from the catalyst particles and, at the same time, to impart sensible heat to the circulating catalyst. The energy carried by the hot regenerator catalyst is used to satisfy the thermal requirements for the reactor 12 of the FCC unit 10.

The FCC unit 10 may have a number of optional units associated with the flue-gas system. In one embodiment, the flue gas may comprise catalyst fines, nitrogen from air used for combustion, products of coke combustions (e.g., oxides of carbon, sulfur, nitrogen, and water vapor), and trace quantities of other compounds. The flue gas exits the regenerator 14 at a high temperature, approximately 600 to 800° C., and at pressures of between about 20 and 50 pounds per square inch guage (psig). The thermal and kinetic energy of the flue gas can be converted to stream or used to drive a turboexpander-generator system for electrical power generation. Unconverted carbon monoxide (CO) in the flue gas can be combusted to CO₂ in a CO boiler with production of high-pressure steam. Catalyst fines may be removed in an electrostatic precipitator.

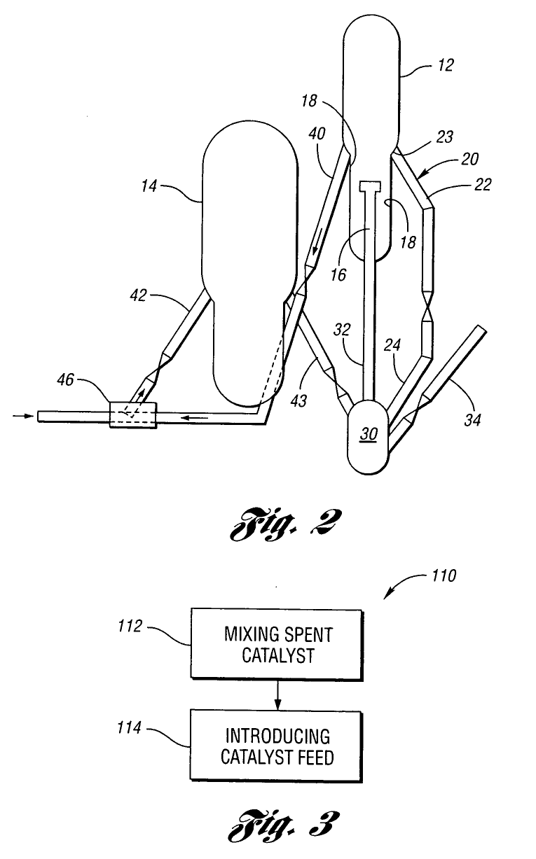

Referring now to FIGS. 1 and 2, from the regenerator 14, hot regenerated catalyst is fed back to the reactor 12 and vaporizes the hydrocarbon feedstock to define resultant vapors. The resultant vapors carry the catalyst upward through a riser 16 of the reactor 12 with a minimum of back mixing. At the top of the riser 16, desired cracking reactions have been completed and the catalyst is quickly separated from the hydrocarbon vapors to minimize secondary reactions. The catalyst-hydrocarbon mixture from the riser is discharged into the reactor vessel through a separation device 18, e.g., a riser termination device, achieving a substantial degree of catalyst-gas separation, e.g., at least 90 weight percent product vapor separation from catalyst. A final separation of catalyst and product vapor may be accomplished by cyclone separation.

The reactor 12 effluent is directed to a main fractionator or fractionation column (discussed in greater detail below) of the FCC unit 10 for resolution into gaseous light olefin co-products, FCC gasoline, and cycle stocks. The spent catalyst drops from within the reactor vessel into a stripping section 18 thereof, where a countercurrent flow of steam removes interstitial and some adsorbed hydrocarbon vapors, defining stripped spent catalyst. Stripped spent catalyst descends through a first standpipe and into the regenerator 14.

As shown in FIGS. 1 and 2, in the operation of the FCC unit 10, fresh feedstock and (depending on product-distribution objectives) recycled cycle oils are introduced into the bottom of the riser 16 together with a controlled amount of regenerated catalyst. The charge may be preheated, either by heat exchange or, for some applications, by means of a fired heater.

Feedstocks for the FCC process include mixtures of hydrocarbons of various types, including relatively small quantities of gasoline to large molecules of 60 carbon atoms. The feedstock may include a relatively small content of contaminant materials such as organic sulfur, nitrogen compounds, and organometallic compounds. It is to be noted that the relative proportions of all such materials will vary with the geographic origin of the crude and the particular boiling range of the FCC feedstock. However, the feedstocks may be ranked in terms of their “crackabilities,” or the ease with which they can be converted in an FCC unit. Crackability is a function of the relative proportions of paraffinic, naphthenic, and aromatic species in the feed.

As shown in FIGS. 1 and 2, one embodiment of the present invention implements a spent catalyst recycle of spent catalyst mixed with fully regenerated catalyst. As will be discussed in greater detail below, one embodiment of the present invention implements a mixing chamber, allowing the riser of the reactor to be fed with a mixture of spent and regenerated catalyst. This decouples the coke yield from the coke content of the catalyst, as catalyst is now able to be recycled until it has built up sufficient coke on average to be sent to the regenerator. Therefore, the FCC unit can run at lower coke yield, while maintaining a high catalyst coke content in the feed to the regenerator, thereby allowing the regenerator to operate in gasification mode with a reasonable syngas yield (see below) as long as sufficient heat is still supplied to the riser to drive the chemical reactions that occur in the riser. This may be applied to a regenerator in either gasification or dry gasification mode. In this embodiment, the regenerator operates in a gasifier mode wherein coke on the FCC catalyst is reacted with steam to produce a mixture of carbon monoxide (CO) and hydrogen (H₂) commonly identified as “syngas.”

FIG. 2 illustrates a system 20 for reducing carbon dioxide emissions in the fluid catalytic cracking (FCC) unit. As shown, the FCC unit comprises the reactor 12 having the system 20 for reducing carbon dioxide emissions and the regenerator 14 in fluid communication with the reactor 12. The reactor 12 comprises a spent catalyst recycle conduit 22 having first and second ends 23, 24. The first end 23 is attached the side of the reactor 12, and is preferably disposed above the riser 16 and the stripping section 18. The recycle conduit 22 extends from first end 23 to the second end 24.

The system 20 further comprises a mixing chamber 30 to which the second end 24 of the recycle conduit 22 is connected and is in fluid communication. The recycle conduit 22 is configured to recycle spent catalyst from the reactor 12 to the mixing chamber 30. Via the recycle conduit 22, the mixing chamber 30 is in fluid communication with the reactor 12. The mixing chamber 30 is configured to mix spent catalyst from the reactor 12 and regenerated catalyst from the regenerator 14 to define a catalyst feed.

As shown in FIG. 2, a catalyst feed conduit 32 is connected to and is in fluid communication with the reactor 12. The catalyst feed conduit 32 extends to the mixing chamber 30. The catalyst feed conduit is configured to introduce the catalyst feed from the mixing chamber to the reactor. In this embodiment, the catalyst feed has a reactor pass to regenerator pass ratio of preferably between about 5:1 and 15:1 under gasification conditions in the regenerator. More preferably, the reactor pass to regenerator pass ratio is about 10:1. The gasification conditions may include a temperature of up to about 600° Celcius and a pressure of about 30 atm in the regenerator.

The system further comprises a fresh-makeup catalyst conduit 34 connect to and in fluid communication with the mixing chamber 30. The fresh-makeup catalyst conduit 34 is used for adding fresh-make up catalyst to the mixing chamber 30 at a predetermined proportional amount relative to the regenerated catalyst to further add to the catalyst feed. In this embodiment, the predetermined proportional amount is the inverse of the number of regenerator passes of the regenerated catalyst in an active state.

As shown, a stripping conduit 40 is connected to and is in fluid communication with the reactor 12 and extends to the regenerator 14. In this embodiment, the stripping conduit 40 is configured to strip spent catalyst from the reactor 12 to the regenerator 14. Preferably, the system further comprises a feed gas conduit 42 connected to and in fluid communication with the regenerator 14. In this embodiment, the feed gas conduit 42 is configured to receive and introduce feed gas and the spent catalyst in the regenerator 14 to reactivate the spent catalyst. The regenerator 14 further includes a reactivated catalyst return conduit in fluid communication with the regenerator and the mixing chamber 30. The return conduit 43 provides reactivated catalyst from the regenerator 14 to the mixing chamber 30.

Preferably, the feed gas comprises a carbon dioxide-oxygen mixture or a steam-oxygen mixture in the gasification mode. In one embodiment, the carbon dioxide-oxygen mixture has a mole ratio of about 3:1 carbon dioxide to oxygen. In another embodiment, the steam-oxygen mixture has a mole ratio of about 3:1 steam-oxygen.

Furthermore, the system further comprises a heat exchanger unit 46. If the flow through of catalyst is substantial, e.g., 5:1 ratio flow rate feed gas to spent catalyst, the heat recovery from the spent catalyst is accomplished by the heat exchanger unit 46. As shown, the heat exchanger unit 46 receives the spent catalyst recycle conduit and the feed gas conduit. The heat exchanger unit configured to exchange heat from the spent catalyst to the feed gas at a rate of recovered heat, thereby preheating the feed gas to reduce carbon dioxide emissions.

Now referring to FIGS. 1 and 2, as mentioned, the FCC unit 10 further includes a main-fractionation column 50 through which the reactor effluent is separated into various products. The main-fractionation comprises an overhead line 52, a first side cut line 54, a second side line 56, a third side cut line 58, and a bottom line 60. As shown, the overhead line 52 includes gasoline and lighter material, the first side cut line 54 includes naphtha, the second side cut line 56 includes light cycle oil, the third side cut line 58 includes heavy cycle oil, and the bottom line 60 includes slurry oil. The lines may include other products without falling beyond the scope or spirit of the present invention.

Reactor-product vapors are directed to the main fractionator 50 at which gasoline and gaseous olefin-rich co-products are taken overhead and routed to a gas-concentration unit 70. At the main-fractionator 50, light-cycle oil is recovered as a side cut with the net yield of this material being stripped for removal of light ends and sent to storage. Net column bottoms are yielded as slurry or clarified oil. Because of the high efficiency of the catalyst-hydrocarbon separation system utilized in the reactor design, catalyst carry-over to the fractionator 50 is minimized and it is not necessary to clarify the net heavy product yielded from the bottom of the fractionator 50 unless the material is to be used in some specific application requiring low solids content such as the production of carbon black. In some instances, heavy material can be recycled to the reactor riser 16.

Maximum usage is made of the heat available at the main column 50. Typically, light-cycle and heavy-cycle oils are utilized in the gas-concentration section 70 for heat-exchange purposes, and steam is generated by circulating main-column bottoms stream.

In this embodiment, the FCC unit 10 further includes the gas-concentration column 70 or an “unsaturated gas plant” in fluid communication with overhead line of the main-fractionation column 50. From the overhead line 52, the gas-concentration column 50 receives unstable gasoline and lighter products that are separated therethrough into fuel gas for alkylation, polymerization, and debutanized gasoline.

The gas-concentration section 70, or unsaturated-gas plant, may be one or an assembly of absorbers and fractionators that separate the main-column overhead into gasoline and other desired light products. Olefinic gases from other processes such as coking may be also sent to the FCC gas-concentration section. The gas-concentration unit may have one or a plurality of columns. For example, the gas-concentration unit may be a “four-column” gas-concentration plant comprising a primary absorber, a secondary absorber, a stripper, and a debutanizer. In this embodiment, gas from the FCC main-column overhead receiver is compressed and directed to the gas-concentration unit.

As shown, the main-fractionation column 50 and the gas-concentration unit 70 remove the hydrogen sulfide and a portion of the carbon dioxide from the flue gas to define the first gas at the inlet pressure. For use within the FCC unit, the catalyst used may be any suitable catalyst including low-activity amorphous catalysts to very-high-activity zeolite-containing catalysts having at least 45% activity.

FIG. 3 depicts one method 110 of reducing carbon dioxide emissions in the fluid catalytic cracking unit mentioned above. The method 110 comprises mixing in box 112 spent catalyst from the reactor and regenerated catalyst from the regenerator to define a catalyst feed. This may be accomplished with the mixing chamber and the recycle conduit mentioned above.

In one example, the step of mixing comprises adding fresh-make up catalyst at a predetermined proportional amount relative to the regenerated catalyst to define the catalyst feed. In this example, the fresh-make up catalyst may be added via the fresh-makeup catalyst conduit mentioned above. Preferably, the predetermined proportional amount is the inverse of the number of regenerator passes of the regenerated catalyst in an active state.

The method further includes introducing in box 114 the catalyst feed in the reactor of the FCC unit to react with a reactor feedstock. This may be accomplished by the catalyst feed conduit mentioned above. In this example, the catalyst feed has a reactor pass to regenerator pass ratio of preferably between about 5:1 and 15:1 under gasification conditions in the regenerator. More preferably, the reactor pass to regenerator pass ratio is about 10:1. Preferably, the gasification conditions include up to about 600° Celcius and about 30 atm in the regenerator.

The step of introducing the catalyst feed comprises introducing the reactor feedstock in the reactor and reacting the feedstock with the catalyst feed to crack the mixtures of hydrocarbons. The feedstock may comprise mixtures of hydrocarbons of molecules of up to about 60 carbon atoms.

In this example, the method further comprises stripping the spent catalyst from the reactor via the stripping conduit mentioned above, and introducing feed gas and spent catalyst via the feed gas conduit to reactivate the spent catalyst in the regenerator. Preferably, the feed gas comprises a carbon dioxide-oxygen mixture or a steam-oxygen mixture in a gasification mode. In one example, the carbon dioxide-oxygen mixture has a mole ratio of about 3:1 carbon dioxide to oxygen. In another example, the steam-oxygen mixture has a mole ratio of about 3:1 steam-oxygen.

In this example, the method further comprises recycling the spent catalyst for mixing with the regenerated catalyst, and recovering heat from the spent catalyst to define a rate of recovered heat. The feed gas is then heated with the rate of recovered heat from the spent catalyst. This may be accomplished by way of a heat exchanger unit.

While the present invention has been described in terms of preferred embodiments, it will be understood, of course, that the invention is not limited thereto since modifications may be made to those skilled in the art, particularly in light of the foregoing teachings.

1. A method of reducing carbon dioxide emissions in a fluid catalytic cracking unit having a regenerator and reactor, the method comprising:
mixing spent catalyst from the reactor and regenerated catalyst from the regenerator to define a catalyst feed; and
introducing the catalyst feed to the reactor of the fluid catalytic cracking unit to react with a reactor feedstock, the catalyst feed having a reactor pass to regenerator pass ratio of between about 5:1 and 15:1 under predetermined conditions in the regenerator.

2. The method of claim 1 wherein mixing further comprises adding fresh-make up catalyst at a predetermined proportional amount relative to the regenerated catalyst to define the catalyst feed.

3. The method of claim 2 wherein the predetermined proportional amount is the inverse of the number of regenerator passes of the regenerated catalyst in an active state.

4. The method of claim 1 wherein the predetermined conditions are gasification conditions including up to about 600° Celcius and about 30 atm in the regenerator.

5. The method of claim 1 wherein introducing the catalyst feed comprises:
introducing the reactor feedstock in the reactor, the feedstock comprising mixtures of hydrocarbons of molecules of up to about 60 carbon atoms; and
reacting the feedstock with the catalyst feed to crack the mixtures of hydrocarbons.

6. The method of claim 1 further comprising:
stripping the spent catalyst from the reactor; and
introducing feed gas and spent catalyst to reactivate the spent catalyst in the regenerator, the feed gas comprising one of carbon dioxide-oxygen mixture and steam-oxygen mixture in a gasification mode.

7. The method of claim 6 wherein the carbon dioxide-oxygen mixture has a mole ratio of about 3:1 carbon dioxide to oxygen.

8. The method of claim 6 wherein the steam-oxygen mixture has a mole ratio of about 3:1 steam-oxygen.

9. The method of claim 6 further comprising:
recycling the spent catalyst for mixing with the regenerated catalyst;
recovering heat from the spent catalyst to define a rate of recovered heat; and
heating the feed gas with the rate of recovered heat from the spent catalyst.

10. The method of claim 1 wherein the reactor pass to regenerator pass ratio is about 10:1.

11. A method of reducing carbon dioxide emissions in a fluid catalytic cracking unit having a regenerator and a reactor, the method comprising:
stripping spent catalyst from the reactor;
mixing the spent catalyst from the reactor, regenerated catalyst from the regenerator, and fresh-makeup catalyst to define a catalyst feed, the fresh-makeup catalyst being at a predetermined proportional amount relative to the regenerated catalyst;
introducing the catalyst feed in the reactor to react with a reactor feed stock, the catalyst feed having a reactor pass to regenerator pass ratio of between about 5:1 and 15:1;
recovering heat from the spent catalyst of the reactor to define a rate of recovered heat;
heating feed gas of the regenerator with the rate of recovered heat from the spent catalyst defining a preheated feed gas, the preheated feed gas comprising one of carbon dioxide-oxygen mixture and steam-oxygen mixture; and
introducing the preheated feed gas and the spent catalyst in the regenerator to reactivate the spent catalyst.

12. The method of claim 11 wherein the predetermined proportional amount is the inverse of the number of regenerator passes of the regenerated catalyst in an active state.

13. The method of claim 11 wherein the feed gas comprises a temperature of up to about 600 degrees Celsius and a pressure of about 30 atmosphere in the regenerator.

14. The method of claim 11 wherein the carbon dioxide-oxygen mixture has a mole ratio of about 3:1 carbon dioxide to oxygen.

15. The method of claim 11 wherein the steam-oxygen mixture has a mole ratio of about 3:1 steam to oxygen.

16. The method of claim 11 wherein the reactor pass to regenerator pass ratio is about 10:1.

17. A system for reducing carbon dioxide emissions in a fluid catalytic cracking system having a regenerator and reactor, the system comprising:
a spent catalyst recycle conduit in fluid communication with the reactor, the recycle conduit configured to recycle spent catalyst from the reactor;
a mixing chamber in fluid communication with the recycle conduit, the mixing chamber configured to mix spent catalyst from the reactor and regenerated catalyst from the regenerator to define a catalyst feed; and
a catalyst feed conduit in fluid communication with the reactor and the mixing chamber, the catalyst feed conduit configured to introduce the catalyst feed in the reactor of the system, the catalyst feed having a reactor pass to regenerator pass ratio of between about 5:1 and 15:1 under gasification conditions in the regenerator.

18. The system of claim 17 further comprising:
a stripping conduit in fluid communication with the reactor and the regenerator, the stripping conduit configured to strip spent catalyst from the reactor to the regenerator; and
a feed gas conduit in fluid communication with the regenerator, the feed gas conduit configured to introduce feed gas with spent catalyst in the regenerator to reactivate the spent catalyst, the feed gas comprising one of carbon dioxide-oxygen mixture and steam-oxygen mixture in a gasification mode.

19. The system of claim 17 further comprising:
a heat exchanger unit receiving the spent catalyst recycle conduit and the feed gas conduit, the heat exchanger unit configured to exchange heat from the spent catalyst to the feed gas at a rate of recovered heat, thereby preheating the feed gas to reduce carbon dioxide emissions.

20. The system of claim 17 wherein the mixing chamber further comprises a fresh-makeup catalyst conduit for adding fresh-make up catalyst at a predetermined proportional amount relative to the regenerated catalyst to define the catalyst feed.

21. The system of claim 20 wherein the predetermined proportional amount is the inverse of the number of regenerator passes of the regenerated catalyst in an active state.

22. The system of claim 17 wherein the gasification conditions include a temperature of up to about 600° Celcius and a pressure of about 30 atm in the regenerator.

23. The system of claim 18 wherein the carbon dioxide-oxygen mixture has a mole ratio of about 3:1 carbon dioxide to oxygen.

24. The system of claim 18 wherein the steam-oxygen mixture has a mole ratio of about 3:1 steam-oxygen.

25. The system of claim 17 wherein the reactor pass to regenerator pass ratio is about 10:1.
